(19) United States
(12) Patent Application Publication
(10) Pub. No.: US 2011/0111613 A1
(43) Pub. Date: May 12, 2011

(54) ROTATABLE POWER ADAPTER

(75) Inventors: PING-SHENG SU, Tu-Cheng (TW); DA-WEI XING, Kunshan (CN)

(73) Assignee: HON HAI PRECISION INDUSTRY CO., LTD., Tu-Cheng (TW)

(21) Appl. No.: 12/943,033

(22) Filed: Nov. 10, 2010

(30) Foreign Application Priority Data
Nov. 10, 2009 (CN) 200920314473.3

(51) Int. Cl. H01R 13/52; H01R 27/02

(52) U.S. Cl. 439/271; 439/628

(57) ABSTRACT

A power adapter (100) comprises a plug connector (10) and a receptacle connector (20). The plug connector has a plug housing (11), a tubular contact (12) received in the plug housing and a cover (14) enclosing the plug housing. The receptacle connector has a receptacle housing (21) and a columned contact (22) assembled to the receptacle housing. The cover defines a passageway (146) with a stopping portion (147) protruding inwards from an inner wall of the passageway, and the receptacle connector defines a latching portion (2141) received in the passageway and adjacent to the stopping portion.

### BACKGROUND OF THE INVENTION

1. Field of the Invention

The present invention generally relates to a power adapter, and more particularly to a power adapter for establishing an electrical connection of a photovoltaic module for a solar system.

2. Description of Related Art

As finity of nonrenewable energy resources and development of environmental protection, developing and utilizing solar energy becomes an inevitable trend. Photovoltaic conversion device converts solar radiation to electrical power by solar photovoltaic technology, and the photovoltaic conversion device usually works with semiconductor components, additionally, an electrical connector assembly realizing an electrical connection is required in the conversion and named solar connector.

A plurality of electrical connectors are arranged on a solar panel conventionally to convent solar radiation to electrical power, and the solar electrical connectors also need some power adapters to connect the plug connector and the receptacle connector. As the solar panel has so many solar connectors, the two opposite ends of the power adapter are connected with corresponding cable connectors, and the cables of the cable connectors are twisted and disposed on the solar panel, however the cable will be broken if be twisted terribly, and the electrical connection will be turned off.

Hence, it is desirable to have an improved structure to overcome the above-mentioned disadvantages of the prior art.

### BRIEF SUMMARY OF THE INVENTION

Accordingly, the object of the present invention is to provide a rotatable power adapter freely.

In order to achieve the above-mentioned object, a power adapter comprises a plug connector and a receptacle connector. The plug connector has a plug housing, a tubular contact received in the plug housing and a cover enclosing the plug housing. The receptacle connector has a receptacle housing and a columned contact assembled to the receptacle housing. The cover defines a passageway with a stopping portion protruding inwards from an inner wall of the passageway, and the receptacle connector defines a latching portion received in the passageway and adjacent to the stopping portion.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is an assembled view of a power adapter in accordance with the present invention;

FIG. 2 is similar to FIG. 1, but viewed from another aspect;

FIG. 3 is an exploded, perspective view of the power adapter shown in FIG. 1;

FIG. 4 is similar to FIG. 3, but viewed from another aspect;

FIG. 5 is a partially exploded, perspective view of the power adapter shown in FIG. 1;

FIG. 6 is similar to FIG. 5, but viewed from another aspect; and

FIG. 7 is a cross-section view of the power adapter shown in FIG. 1.

### DETAILED DESCRIPTION OF THE INVENTION

Reference will now be made to the drawing figures to describe the present invention in detail.

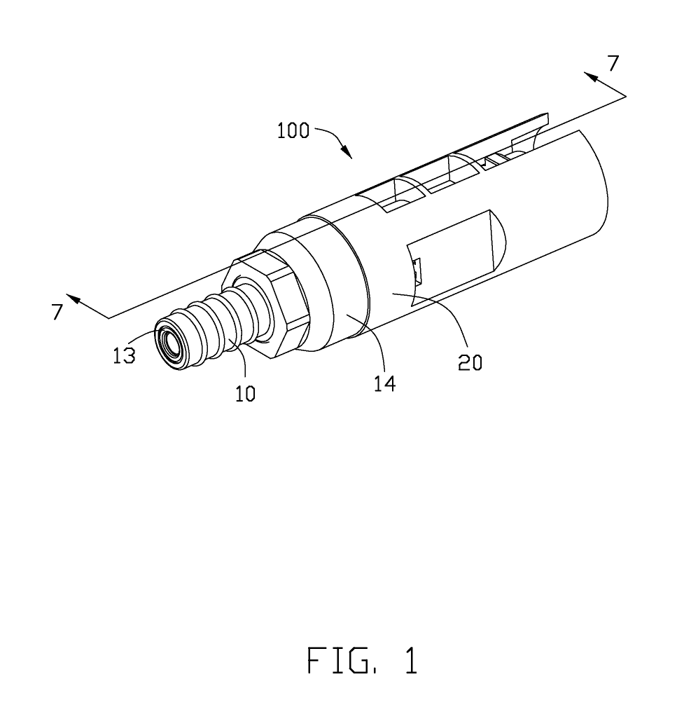

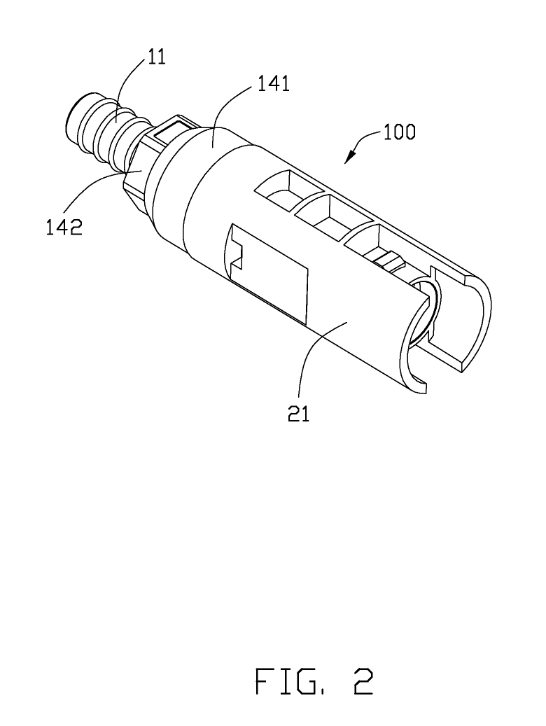

Referring to FIGS. 1-2, a power adapter 100 made in accordance with the present invention comprises a plug connector 10 and a receptacle connector 20, and a cover 14 of the plug connector 10 is connected the receptacle connector 20 and the plug connector 10 to form a rotatable configuration.

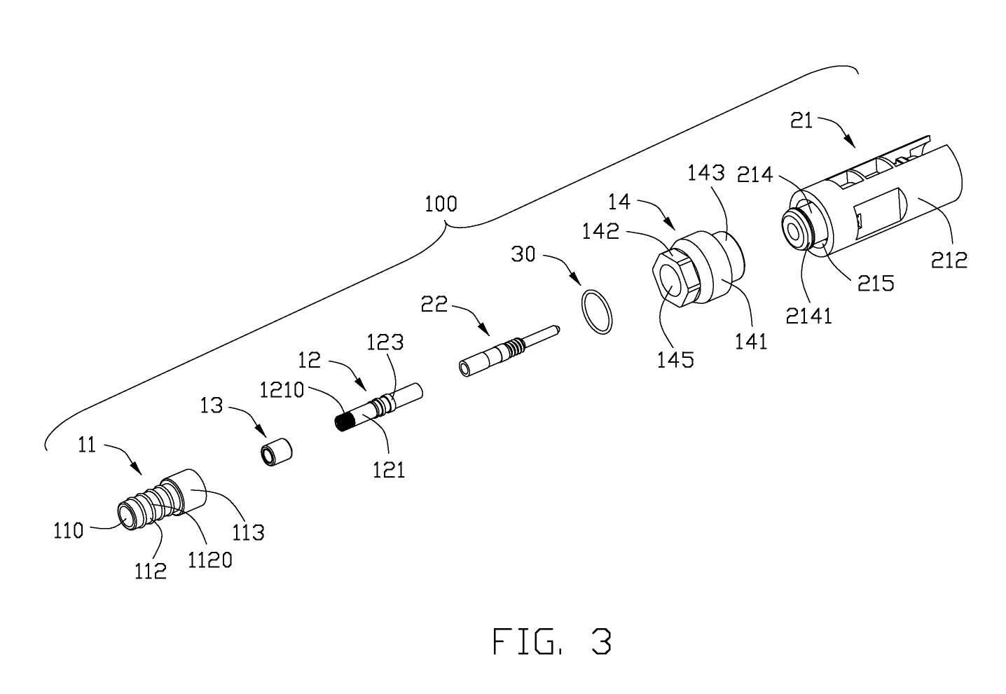

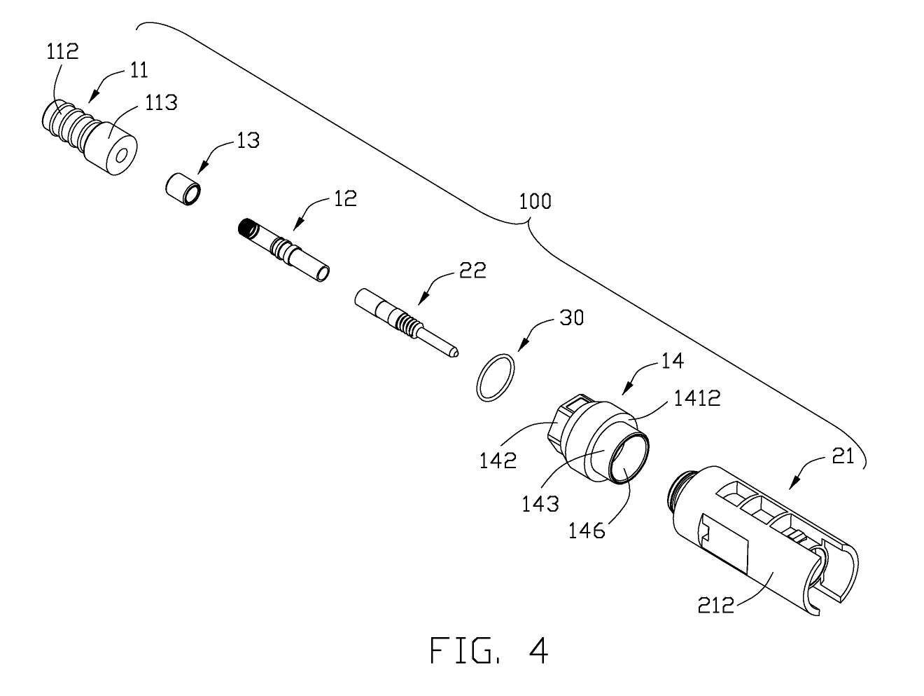

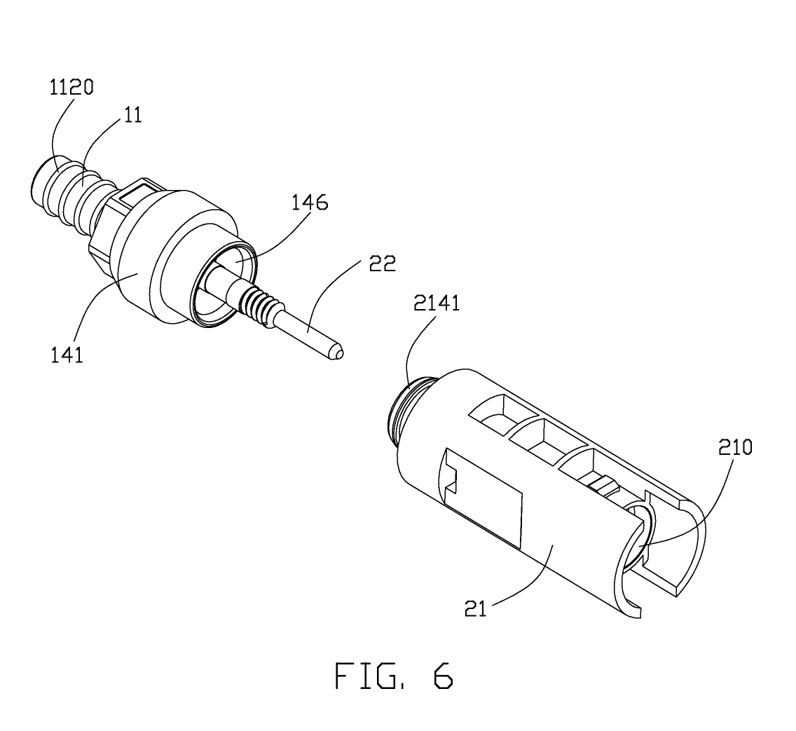

Referring to FIGS. 3-6, the plug connector 10 comprises a plug housing 11, a tubular contact 12 accommodated in the plug housing 11, and a cover 14 molded over the plug housing 11. The plug housing 11 is made of Thermoplastic Vulcanizate and other thermoplastic rubber material. The plug housing 11 comprises a cylindrical main portion 112 and an enlarged portion 113 extending rearwards from the main portion 112, the diameter of the enlarged portion 113 is bigger than the main portion 112. The main portion 112 defines a cavity 110 recessed along a front-to-back direction. The main portion 112 defines a plurality of ribs 1120 protruding outwards from an external surface to cooperate with a complementary connector.

The tubular contact 12 is made of metallic material, and comprises a columnar body portion 121 and a matching portion 123 extending outwards from the body portion 121. The tubular contact 12 has a thread on an exterior surface thereof. The plug connector 10 also defines an elastic sealing washer 13, the sealing washer 13 is made of rubber material and over-molded on a front end 1210 of the tubular contact 12.

The cover 14 is made of plastic material and comprises a base portion 141, a retaining portion 142 extending forwards from the base portion 141, and an extrusion portion 143 extending rearwards from a back surface 1412 of the base portion 141. The cover 14 also defines a first passageway 145 located in a front section and a second passageway 146 in a back section thereof, the second passageway 146 is connected with the first passageway 145, and the first passageway 145 has a smaller diameter than the second passageway 146. The second passageway 146 has a ringed stopping portion 147 on an inner wall thereof, and the stopping portion 147 defines a guiding surface 1470 slantly extending towards an interior side thereof.

The receptacle connector 20 comprises a receptacle housing 21 and a columned contact 22 received in the receptacle housing 21. The receptacle housing 21 has a cylindrical receiving portion 212 and a linking portion 214 extending forwards from the receiving portion 212, and a receiving space 210 is recessed in the receiving portion 212. The receiving portion 212 defines a ring portion 2121 on a front end thereof, and an outer wall of the linking portion 214 is spaced apart from an inner wall of the ring portion 2121 with a certain distance to form a ringed aperture 215. The linking portion 214 defines a latching portion 2141 protruding outwards from a front end thereof, and the latching portion 2141 has a diameter becoming larger from front to back. In other embodiment, the latching portion 2141 can be defined as a plurality of tabs. The columned contact 22 is configured with a tubular portion in the front thereof and a terminal pin at back, and a thread is defined between the tubular portion and the terminal pin.

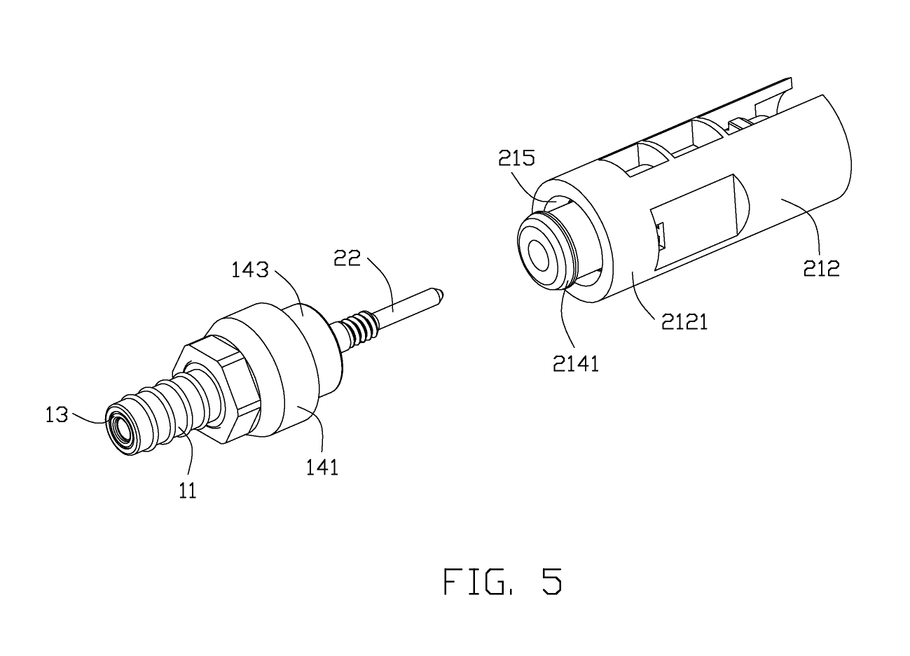

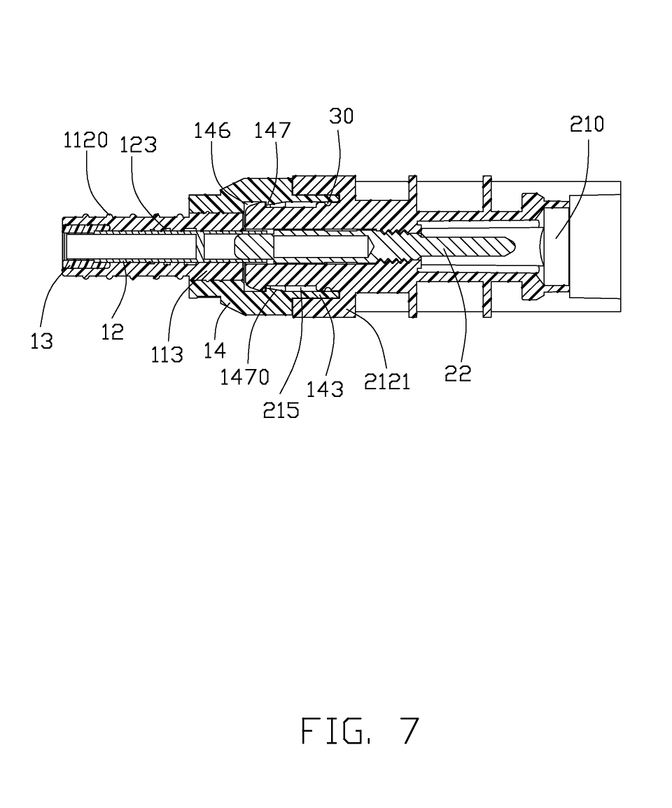

Referring to FIGS. 5-7, in assembly, the elastic sealing washer 13 is molded on the front end of the tubular contact 12 firstly, then the plug housing 11 is molded on the tubular contact 12 and the sealing washer 13, and the tubular contact 12 is interferentially received in the plug housing with the matching portion 123. Simultaneity, the cover 14 is molded on the enlarged portion 113 of the plug housing 11 as the plug housing molded to make the aforementioned components form a unitary structure, that is to say, the cover 14 and the plug housing 11 is enclosing the tubular contact 12 simultaneity. Additionally, the cover 14 is made of hard material than the plug housing 11 to be molded on the plug housing.

In assembly, the columned contact 22 is rotated and retained in the receptacle connector 20 via the thread, and a sealing gasket 30 made of rubber material is enclosing the linking portion 214 of the receptacle connector 20, and then the linking portion 214 of the receptacle connector 20 is inserted into the plug connector 10 along a mating direction, the linking portion 214 is received in the second passageway 146 of the cover 14, the extrusion portion 143 is inserted into the aperture 215 of the receptacle housing 21. The latching portion 2141 of the linking portion 214 is sliding beyond the stopping portion 147 along the guiding surface 1470 in the second passageway 146, and adjacent to the stopping portion 147 to prevent moving back thereof. The tubular contact 12 of the plug connector 10 is mechanically and electrically connected with the columned contact 22. In other selectiveable embodiment, the tubular contact 12 also can be electrically connected with the columned contact 22 via a cable. The gap between the cover 14 and the linking portion 214 is full filled with the sealing gasket 30, and the extrusion portion 143 is matching with the aperture 215 close, to achieve waterproof and dustproof effect. The linking portion 214 of the receptacle connector 20 can rotate in the second passageway 146 in discretionary angle, so the power adapter 100 can rotatably mate with the complementary cable connector on a solar panel, and prevent a cable of the complementary cable connector being twisted and the electrical connection being turned off.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A power adapter, comprising:
a plug connector having a plug housing, a tubular contact received in the plug housing and a cover enclosing the plug housing; and
a receptacle connector having a receptacle housing and a columned contact assembled to the receptacle housing;
wherein the cover defines a passageway with a stopping portion protruding inwards from an inner wall of the passageway, and the receptacle connector defines a latching portion received in the passageway and adjacent to the stopping portion.

2. The power adapter as claimed in claim 1, wherein the receptacle housing of the receptacle connector defines a receiving portion and a linking portion extending forwards from the receiving portion, and the latching portion is defined on the linking portion.

3. The power adapter as claimed in claim 2, wherein the receiving portion defines a ring portion, and an outer wall of the linking portion is spaced apart from an inner wall of the ring portion with a certain distance to form an aperture.

4. The power adapter as claimed in claim 3, wherein the cover defines an extrusion portion on one end, and the extrusion portion is assembled into the aperture of the receptacle connector.

5. The power adapter as claimed in claim 2, wherein a sealing gasket is arranged enclosing the linking portion and in the passageway.

6. The power adapter as claimed in claim 5, wherein the sealing gasket is made of rubber material.

7. The power adapter as claimed in claim 1, wherein the stopping portion defines a guiding surface extending slantly and leading the insertion of the latching portion.

8. The power adapter as claimed in claim 1, wherein the cover is enclosed on a back end of the plug housing.

9. The power adapter as claimed in claim 1, wherein the columned contact of the receptacle connector defines a thread, and the columned contact is inserted into the receptacle housing rotatably.

10. The power adapter as claimed in claim 1, wherein the cover is made of hard material than the plug housing.

11. A power adapter, comprising:
a plug connector having a plug housing and a tubular contact receiving in the plug housing, the plug housing defining a main portion with a plurality of ribs protruding outwards and an enlarged portion extending backwards from the main portion;
a receptacle connector having a receptacle housing and a columned contact assembled in the receptacle housing, the receptacle housing having a tubular receiving portion and a linking portion accommodated in the receiving portion, the linking portion defining a latching portion on a front end thereof, the columned contact defining a tubular portion in the front thereof and a pin behind the tubular portion;
a cover molded on the plug housing and having a passageway for the linking portion being inserted into, and a stopping portion arranged in the passageway and adjacent to the latching portion to prevent the receptacle housing separating from the plug housing.

12. A power adaptor comprising:
a plug including a first insulative housing enclosing a plug contact in a center coaxially, said plug contact having a mating section extending beyond a mating face of the first housing;
a cover coaxially integrally formed with the housing and extending beyond the mating face of the first housing to surround said mating section of the plug contact; and
a receptacle including a second insulative housing enclosing a receptacle contact in a center coaxially; wherein
said second housing includes an engaging section axially confronts the first housing and surrounded in the cover, and interengaging structures are formed on both an interior surface of the cover and an exterior surface of said engaging section to axially engage with each other so as to allow said plug connector to be rotated relative to the receptacle connector without withdrawal.

13. The power adaptor as claimed in claim 12, wherein said interengaging structures protrude radially.

14. The power adaptor as claimed in claim 12, wherein said cover defines a ring-like flange extending into the second housing.
